(19) United States
(12) Patent Application Publication
(10) Pub. No.: US 2020/0079053 A1
(43) Pub. Date: Mar. 12, 2020

(54) INPUT DEVICE AND METHOD FOR MANUFACTURING INPUT DEVICE IN WHICH PLASTIC COVER AND FILM SENSOR ARE LAMINATED

(71) Applicant: Alps Alpine Co., Ltd., Tokyo (JP)

(72) Inventors: Hideto SASAGAWA, Miyagi-ken (JP); Takashi ASAKAWA, Miyagi-ken (JP); Takefumi OSAKA, Miyagi-ken (JP); Yutaka TAKASHIMA, Miyagi-ken (JP)

(21) Appl. No.: 16/682,419

(22) Filed: Nov. 13, 2019

Related U.S. Application Data
(63) Continuation of application No. PCT/JP2018/022895, filed on Jun. 15, 2018.

(30) Foreign Application Priority Data
Aug. 7, 2017 (JP) 2017-152389

(51) Int. Cl. B32B 7/035; B32B 27/08; B32B 27/36; B32B 27/30; G06F 3/044

(52) U.S. Cl. CPC B32B 7/035; B32B 27/08; B32B 27/365; B32B 27/36; G06F 2203/04103; G06F 3/044; B32B 2307/514; B32B 2307/308; B32B 2457/208; B32B 27/308

(57) ABSTRACT

A touch panel is configured such that a plastic cover and a film sensor are laminated so that the resin flowing direction of the plastic cover and the resin flowing direction of the film sensor are not parallel to each other in plan view in the laminating direction. The touch panel is prevented from being degraded in design and becoming nonuniform in sensitivity because of the occurrence of warping, thereby maintaining its appearance and function well under a high-temperature environment.

### CLAIM OF PRIORITY

This application is a Continuation of International Application No. PCT/JP2018/022895 filed on Jun. 15, 2018, which claims benefit of Japanese Patent Application No. 2017-152389 filed on Aug. 7, 2017. The entire contents of each application noted above are hereby incorporated by reference.

### BACKGROUND OF THE INVENTION

### 1. Field of the Invention

The present invention relates to an input device and a method for manufacturing an input device in which a plastic cover and a film sensor are laminated.

### 2. Description of the Related Art

Capacitive touch panels that sense capacitance are used as input devices for use in mobile terminals and various electronic apparatuses.

Japanese Unexamined Patent Application Publication No. 2013-41446 describes a touch panel made of a film base material, which is less prone to thermal deformation during manufacturing. The touch panel has a configuration in which two film base materials with a transparent conductive layer composed of the same material and having the same thickness are laminated so that the film forming directions form 90 degrees.

US Patent Application Publication No. 2012/0268914 describes a touch panel in which two sensor films are laminated so that their lengthwise directions (machine directions [MDs]) cross at right angles to cancel the birefringence of the sensor films.

The touch panels described in Japanese Unexamined Patent Application Publication No. 2013-41446 and US Patent Application Publication No. 2012/0268914 have a configuration in which the film base material forming directions (lengthwise directions) cross at right angles to reduce the anisotropy of the film base materials. However, in these touch panels, the relationship between the film forming directions of the plurality of film base materials composed of the same material and having the same thickness is specified, but the directions of arrangement of the film base materials in relation to other members are not studied.

Furthermore, Japanese Unexamined Patent Application Publication No. 2013-41446 and US Patent Application Publication No. 2012/0268914 do not describe problems in the case where the touch panels are used under a high-temperature environment. For example, car navigation touch panels can have appearance and functional problems when exposed to high temperature. However, the problems that can occur in such a high-temperature environment are not described.

### SUMMARY OF THE INVENTION

The present invention provides an input device whose appearance and functions can be kept well under a high-temperature environment and in which degradation in design and nonuniformity in sensitivity are suppressed. The present invention also provides a method for manufacturing an input device in which a plastic cover and a film sensor are laminated.

The inventors have found that an input device in which a plastic cover and a film sensor are laminated warps greatly under a high-temperature environment in the case where the resin flowing direction of the film sensor and the resin flowing direction of the plastic cover are parallel to each other. The present invention is based on this finding and has the following configuration.

An input device according to the present invention includes a plastic cover and a film sensor laminated together. A resin flowing direction MD1 of the plastic cover and a resin flowing direction MD2 of the film sensor are nonparallel to each other in plan view in a laminating direction. This prevents warping under a high-temperature environment.

Preferably, the resin flowing direction MD1 and the resin flowing direction MD2 cross at right angles in the viewpoint of preventing warping under a high-temperature environment.

The input device according to the present invention may include a casing joined to the plastic cover. In this case, the casing preferably has a frame shape in plan view in the laminating direction and is joined to a periphery of the plastic cover. Preventing the warping under a high-temperature environment allows the plastic cover and the casing to be kept joined.

A method for manufacturing an input device including a plastic cover and a film sensor laminated together includes the step of laminating the plastic cover and the film sensor so that a resin flowing direction MD1 and a resin flowing direction MD2 are nonparallel to each other. This allows stably manufacturing an input device whose appearance and functions are maintained well under a high-temperature environment.

In the method for manufacturing the input device including the plastic cover and the film sensor laminated together according to the present invention, the resin flowing direction MD1 of the plastic cover is, for example, an extruding direction in manufacturing a plastic base material of the plastic cover, and the resin flowing direction MD2 of the film sensor is, for example, a roll drawing direction in manufacturing a film base material of the film sensor.

### BRIEF DESCRIPTION OF THE DRAWINGS

FIG. 1A is a perspective view of a touch panel according to the present embodiment, schematically illustrating the relationship between the resin flowing direction MD1 of a plastic cover and the resin flowing direction MD2 of a film sensor.

FIG. 1B is a schematic diagram illustrating the relationship between MD1 and MD2 in plan view in the laminated direction of the touch panel.

FIG. 2A is a perspective view schematically illustrating a state before the touch panel is mounted to a casing.

FIG. 2B is a perspective view schematically illustrating a state in which the touch panel is mounted to the casing.

FIG. 3 is a cross-sectional view of the touch panel mounted to the casing taken along III-III in FIG. 2B.

FIG. 4 is a cross-sectional view illustrating a state in which the touch panel in FIG. 3 is peeled from the casing because of warping.

FIG. 5 is a graph showing the results of high-temperature (95° C.) environmental testing.

FIG. 6 is a graph showing the results of high-temperature-high-humidity (85° C., 85%) environmental testing.

### DESCRIPTION OF THE PREFERRED EMBODIMENTS

An input device according to an embodiment of the present invention will be described hereinbelow with reference to the drawings. Components with the same functions as those of described components are denoted by the same reference signs, and descriptions thereof will be omitted as appropriate.

A form in which the input device of the present invention is embodied as a capacitive touch panel will be described hereinbelow.

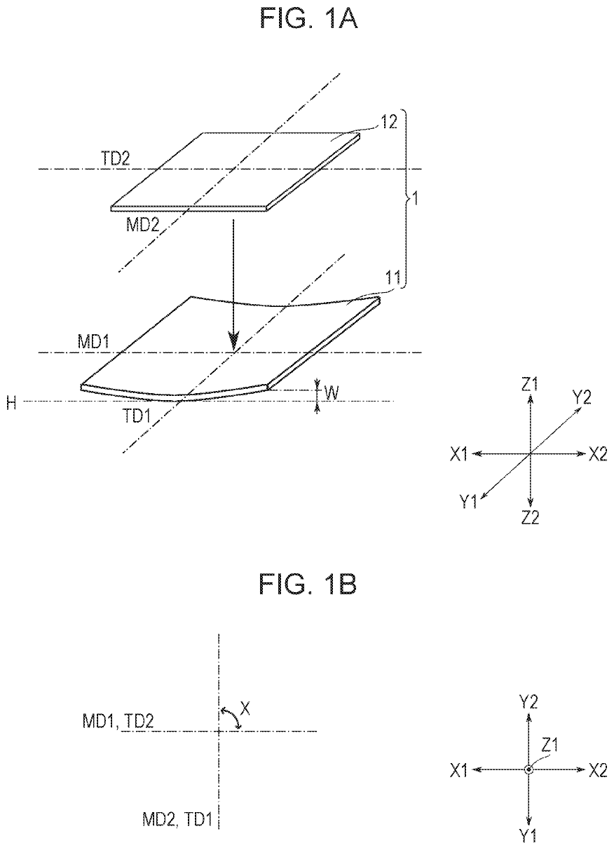

FIG. 1A is a perspective view of a touch panel 1 according to the present embodiment, schematically illustrating the relationship between the resin flowing direction MD1 of a plastic cover 11 (hereinafter referred to as “MD1” or “MD1 direction” as appropriate) and the resin flowing direction MD2 of a film sensor 12 (hereinafter referred to as “MD2” or “MD2 direction” as appropriate). FIG. 1B is a schematic diagram illustrating the relationship between the MD1 direction and the MD2 direction in plan view in the laminated direction.

As illustrated in the diagrams, the plastic cover 11 and the film sensor 12 constituting the touch panel 1 are laminated so that the straight line indicating the MD1 direction of the plastic cover 11 and the straight line indicating the MD2 direction of the film sensor 12 cross at right angles in plan view in the laminated direction (Z1-Z2 direction), that is, the angle X formed by the two directions is 90 degrees.

The plastic cover 11 is manufactured by extrusion molding a plastic base material, such as a polycarbonate resin (PC) or an acrylic resin (polymethyl methacrylate [PMMA]). In this case, the resin flowing direction of the plastic cover 11 is the extruding direction. The resin flowing direction can be confirmed by measuring the birefringence distribution of the plastic cover 11. The plastic cover 11 manufactured by extrusion molding tends to warp along the extruding direction (MD1 direction), as illustrated in FIG. 1A. For example, the plastic cover 11 under a high-temperature environment warps to draw an arc along the MD1 direction. The diagram illustrates a case in which the plastic cover 11 is warped so as to draw an arc protruding in the Z2-direction along the MD1 direction.

The plastic cover 11 may be a single-layer cover composed of one kind of plastic base material or a two-layer cover composed of two kinds of plastic base material laminated together. If the plastic cover 11 is composed of two layers, a PMMA layer and a PC layer, warping tends to occur in a direction in which the PMMA surface protrudes. The plastic cover 11 may have any thickness but normally has a thickness of about 1.0 mm to 3.0 mm, and preferably has a thickness of about 1.5 mm to 2.0 mm.

The film sensor 12 is a film having a function for sensing capacitance. For example, the film sensor 12 is configured such that an electrode layer (not illustrated) and so on are disposed on a film base material layer manufactured by forming a light-transmissive polyethylene terephthalate (PET) film by drawing. In this case, the resin flowing direction MD2 of the film sensor 12 (film base material layer) is the drawing direction. The resin flowing direction can be confirmed by measuring the birefringence distribution of the film base material layer. The film sensor 12 tends to contract in the direction of drawing during manufacture (the roll direction, the vertical direction, or the MD2 direction) under a high-temperature environment. The coefficient of linear expansion of the film sensor 12 in the MD2 direction depends on the kind of resin constituting the film sensor 12, the condition of manufacture, and so on. For example, the coefficient of linear expansion of a PET film is generally about 1.2×10-5. The film sensor 12 may have any thickness but normally has a thickness of 200 μm or less, and preferably has a thickness of 100 μm or less.

As illustrated in FIGS. 1A and 1B, the touch panel 1 has its film sensor 12 laminated on the plastic cover 11 in such a manner that the MD2 is orthogonal to the MD1. Therefore, the MD1 of the plastic cover 11 is parallel to the transverse direction (TD) (the direction crossing the flow of the resin) 2 of the film sensor 12, and the MD2 of the film sensor 12 is parallel to the TD1 of the plastic cover 11. This configuration allows the film sensor 12 to suppress the warping of the plastic cover 11 in the MD1 direction and the plastic cover 11 to suppress the contraction of the film sensor 12 in the MD2 direction under a high-temperature environment.

The angle X between the MD1 direction and the MD2 direction of the touch panel 1 is 90 degrees. This allows effectively preventing the warping of the plastic cover 11 in the MD1 direction and the contraction of the film sensor 12 in the MD2 direction. However, laminating them such that the MD1 direction and the MD2 direction cross or are nonparallel provides the effect of preventing the warping of the plastic cover 11 and the contraction of the film sensor 12. Therefore, the above effect can be obtained even if the angle X (FIG. 1B is not 90 degrees. The angle X is preferably from 45 degrees to 135 degrees, and more preferably from 80 degrees to 100 degrees in the viewpoint of effectively preventing the warping and contraction.

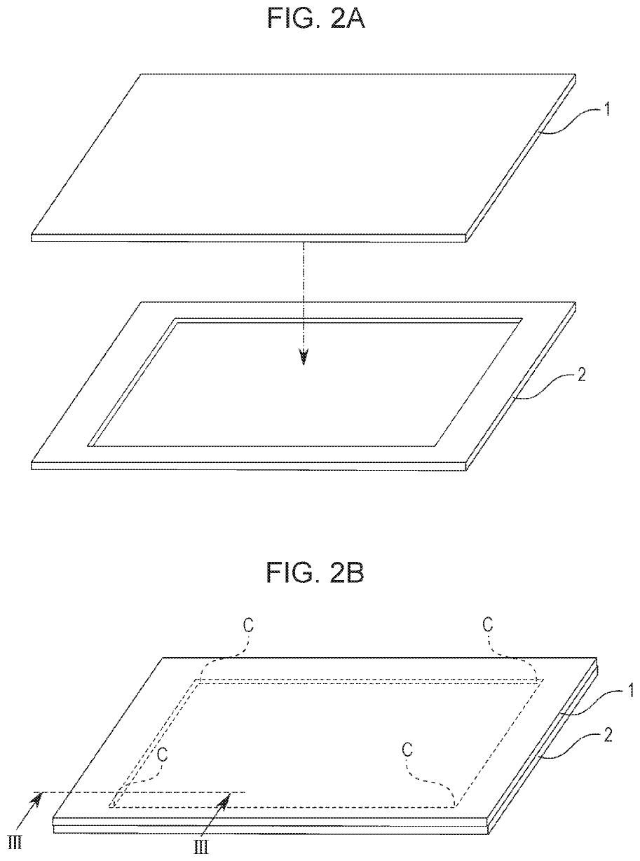

As illustrated in FIGS. 2A and 2B, the touch panel 1 is joined (bonded) to a frame-like casing 2 enclosing the periphery thereof.

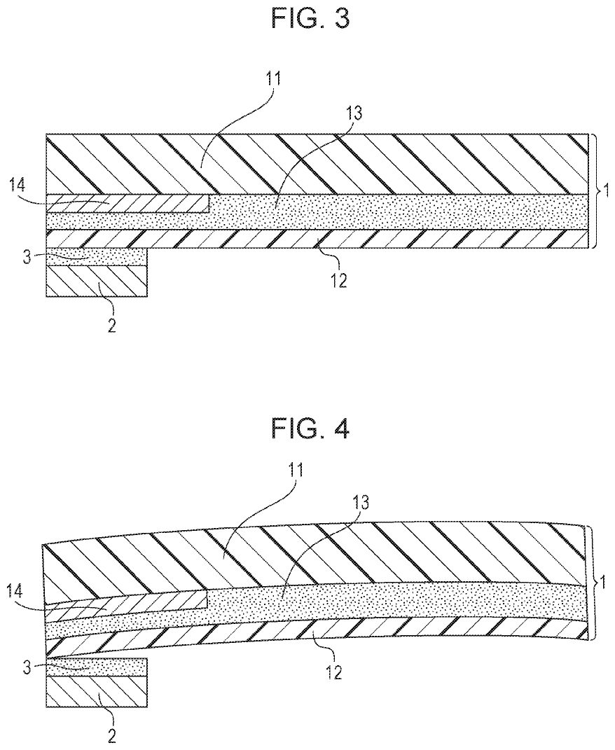

FIG. 3 is a cross-sectional view taken along III-III in FIG. 2B. As illustrated in the diagram, the film sensor 12 of the touch panel 1 is joined at one surface to the casing 2 with an adhesive layer 3 therebetween, and joined at the other surface to the plastic cover 11 with an optical transparent adhesive layer 13 (an optical clear adhesive [OCA]) therebetween. The optical transparent adhesive layer 13 is composed of, for example, acrylic adhesive, and has a thickness of about 25 μm to 200 μm. A decorative layer 14 is disposed between the plastic cover 11 and the film sensor 12.

FIG. 4 illustrates a state in which the touch panel 1 is peeled from the casing 2 because of warping. The use under a high-temperature environment causes a force in a direction in which the touch panel 1 warps, that is, a direction in which the touch panel 1 and the casing 2 are separated. When the force becomes large and the state bonded by the adhesive layer 3 cannot be maintained, the touch panel 1 peels from the casing 2, advancing the warping. The peeling tends to occur from the vicinity of the corners C of the touch panel 1 (see FIG. 2B).

The occurrence of peeling itself is a problem in the viewpoint of appearance, but if the warping of the touch panel 1 is advanced by peeling, the appearance (design) of the touch panel 1 may be further deteriorated. For example, if the warping applies stress to the decorative layer 14 disposed on the periphery of the touch panel 1, its appearance may become nonuniform.

The warping of the touch panel 1 may also cause functional problems. For example, if the force applied to the film sensor 12 becomes nonuniform because of warping, the sensitivity distribution may become nonuniform. Furthermore, air bubbles can be generated between the plastic cover 11 and the film sensor 12. In this case, the sensitivity distribution of the touch panel 1 becomes more nonuniform because the dielectric constant of the film sensor 12 depends on whether there are air bubbles.

For this reason, as illustrated in FIG. 1, the touch panel 1 is configured such that the resin flowing direction MD1 of the plastic cover 11 and the resin flowing direction MD2 of the film sensor 12 cross or are nonparallel to each other. This allows the film sensor 12 to suppress the warping of the plastic cover 11 under a high-temperature environment, thereby maintaining the state in which the touch panel 1 and the casing 2 are joined.

The present invention may also be embodied as a method of manufacture including the step of laminating the plastic cover 11 and the film sensor 12 so that the resin flowing direction MD1 and the resin flowing direction MD2 cross or are nonparallel. Lamination such that MD1 and MD2 cross or are nonparallel allows the warping of the plastic cover 11 under a high-temperature environment to be prevented by the film sensor 12.

For example, the resin flowing direction MD1 of the plastic cover 11 is an extruding direction in manufacturing the plastic base material of the plastic cover 11. For example, the resin flowing direction MD2 of the film sensor 12 is a roll stretching direction in manufacturing the film base material of the film sensor 12. In this case, lamination such that MD1 and MD2 cross or are nonparallel allows the warping of the plastic cover 11 under a high-temperature environment to be prevented by the film sensor 12.

Accordingly, the method of manufacture including the lamination step described above allows stably manufacturing the touch panel 1 in which the frame-shaped casing 2 is joined to the periphery of the plastic cover 11, which maintains the joined state under a high-temperature environment so that no peeling occurs.

### EXAMPLES

The following shows the results of environmental testing of the plastic cover 11, the film sensor 12, and the touch panel 1 in which they are laminated under a high-temperature environment (95° C.) and a high-temperature, high-humidity environment (85° C., relative humidity: 85%).

### Example

Method of Measurement:

Environmental condition (atmosphere): high temperature (95° C.), high temperature·high humidity (85° C., relative humidity: 85%)

Storage time: 120 hours, 240 hours

Measurement: The specimen was stored under a predetermined environment for a predetermined time, then it was left at room temperature for two hours for cooling, and was thereafter measured. The specimen was placed on a horizontal plane H. The distance of the highest portion in side view from the horizontal plane H was set as the size of the warp, W (see FIG. 1A).

Measurement Specimen:

Orthogonally laminated touch panel: The plastic cover and the film sensor were laminated so that the MD1 direction and the MD2 direction cross at right angles in plan view in the laminating direction (angle X=90 degrees, see FIG. 1B).

Plastic cover: two kinds, two layers (PMMA/PC), 9 inch (200×125 mm, thickness t: 2 mm)

Film sensor: PET, 9 inch (200×125 mm, thickness t: 50 μm)

Frame-shaped casing: PC, 9 inch (200×125 mm, thickness t: 2 mm, frame width: 5 to 30 mm)

Adhesive layer: acrylic

### Comparative Example

Method of Measurement:

Environmental condition (atmosphere): high temperature (95° C.), high temperature·high humidity (85° C., relative humidity: 85%)

Storage time: 120 hours, 240 hours

Measurement: The specimen was stored under a predetermined environment for a predetermined time, then it was left at room temperature for two hours for cooling, and was thereafter measured. The specimen was placed on a horizontal plane H. The distance of the highest portion in side view from the horizontal plane H was set as the size of the warp, W (see FIG. 1A).

Measurement Specimen:

Plastic cover: two kinds, two layers (PMMA/PC), 9 inch (200×125 mm, thickness t: 2 mm)

Film sensor: PET, 9 inch (200×125 mm, thickness t: 50 μm)

Parallel laminated touch panel: The plastic cover and the film sensor were laminated so that the MD1 direction and the MD2 direction are parallel in plan view in the laminating direction (angle X=0 degrees, see FIG. 1B).

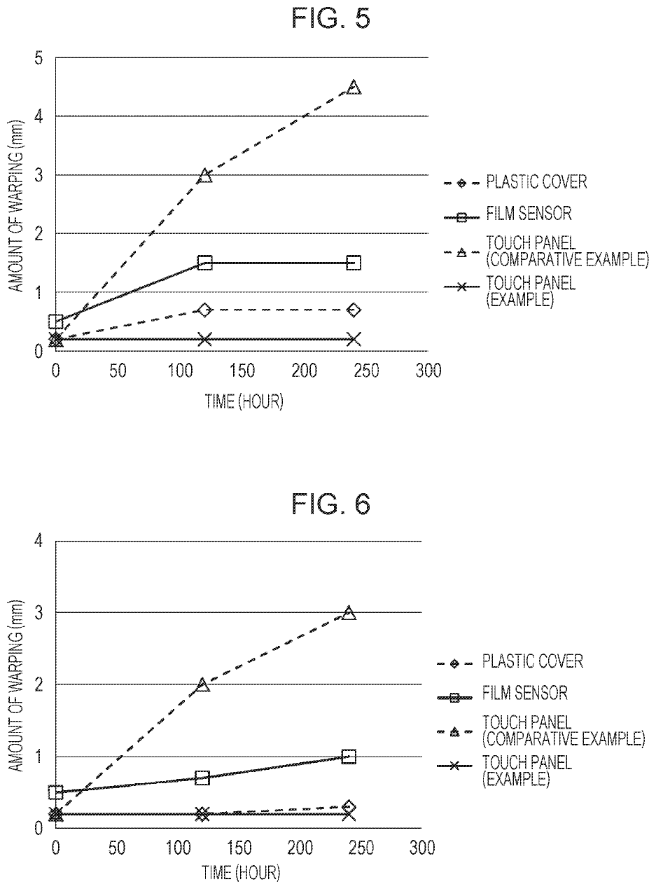

Table 1 and FIGS. 5 to 6 show the results of measurement of the sizes of the warps of the individual specimens after environmental testing under a high-temperature and a high-temperature, high-humidity environment (atmosphere).

### <High-Temperature (95° C.) Environment>)

TABLE 1

| Warping | Plastic | Film | Touch panel | |
|---|---|---|---|---|
| (mm) | cover | sensor | Example | Comparative example |
| Initial stage | 0.2 | 0.5 | 0.2 | 0.2 |
| 120 hours | 0.7 | 1.5 | 0.2 | 3.0 |
| 240 hours | 0.7 | 1.5 | 0.2 | 4.5 |

As shown in Table 1 and FIG. 5, the touch panel of the comparative example in which the plastic cover and the film sensor are laminated so that the MD1 direction and the MD2 direction are parallel was warped because it was stored under a high-temperature environment. The amount of warping of the touch panel was larger than the total amount of the warping of the plastic cover and the film sensor evaluated separately. Thus, when the plastic cover and the film sensor were laminated so that the MD1 direction and the MD2 direction are parallel to each other, the amount of warping of the touch panel was large due to their synergistic action.

As shown in Table 1 and FIG. 5, the touch panel of the example in which the plastic cover and the film sensor are laminated so that the MD1 direction and the MD1 direction cross at right angles (the orthogonally laminated touch panel) maintained the initial amount of warping, having no change, even stored under a high-temperature environment.

The same evaluation was made on input devices in which the periphery of the orthogonally laminated touch panel of the example is joined to a frame-shaped casing whose outer shape is the same as that of the touch panel in plan view in the laminating direction. Three input devices including the touch panel and the casing were produced and tested under a high-temperature environment. As a result, no peeling occurred in any of the three input devices.

Thus, laminating the plastic cover and the film sensor so that the MD1 direction and the MD2 direction are not parallel prevented large warping under a high-temperature environment, providing an input device having no appearance and functional problems.

### <High-Temperature, High-Humidity (85° C., 85%) Environment>

TABLE 2

| Warping | Plastic | Film | Touch panel | |
|---|---|---|---|---|
| (mm) | cover | sensor | Example | Comparative example |
| Initial stage | 0.2 | 0.5 | 0.2 | 0.2 |
| 120 hours | 0.2 | 0.7 | 0.2 | 2.0 |
| 240 hours | 0.3 | 1.0 | 0.2 | 3.0 |

As illustrated in Table 2 and FIG. 6, the results of the comparative example under a high-temperature, high-humidity environment showed that laminating the plastic cover and the film sensor so that the MD1 direction and the MD2 direction are parallel to each other causes large warping of the touch panel, similarly to the case under a high-temperature environment.

In the conventional manufacture of a touch panel including a plastic cover and a film sensor, the laminating direction thereof (the angle X between MD1 and MD2, see FIG. 1B) has not been taken into consideration. For this reason, the touch panels manufactured by the conventional method of manufacture include touch panels in which the laminating directions are parallel (angle X=0 degrees), possibly causing problems in appearance and function of the parallel laminated touch panel under a high-temperature environment.

As shown in Table 2 and FIG. 6, the touch panel of the example in which the plastic cover and the film sensor are laminated so that the MD1 direction and the MD1 direction cross at right angles (the orthogonally laminated touch panel) maintained the initial amount of warping, having no change, even stored under a high-temperature, high-humidity environment.

The same evaluation was made on input devices in which the periphery of the orthogonally laminated touch panel is joined to a frame-shaped casing whose outer shape is the same as that of the touch panel in plan view in the laminating direction. Three input devices including the touch panel and the casing were produced and tested under a high-temperature, high-humidity environment. As a result, no peeling occurred in any of the three input devices.

Thus, laminating the plastic cover and the film sensor so that the MD1 direction and the MD2 direction are not parallel prevented large warping under a high-temperature, high-humidity environment, providing an input device having no appearance and functional problems.

Thus, laminating the plastic cover and the film sensor so that the resin flowing direction MD1 and the resin flowing direction MD2 are not parallel prevents the touch panel from warping under a high-temperature environment and a high-temperature, high-humidity environment, allowing stably manufacturing a touch panel with high appearance and functional reliability and an input device including such a touch panel.

The present invention is not limited to the above embodiment and example and includes the same forms in technical spirit.

An input device according to the present invention is not degraded in design and does not become nonuniform in input sensitivity due to warping under a high-temperature environment, so that the appearance and functions can be well maintained. The input device is therefore useful for an input device installed in a possibly high-temperature environment, such as a touch panel for car navigation.

1. An input device comprising:
a plastic cover made of a first resin base material having a first resin flow direction; and
a film sensor made of a second resin base material having a second resin flow direction, the film sensor being laminated onto the plastic cover in a laminating direction,
wherein the first resin flow direction and the second resin flow direction are nonparallel to each other in a plan view in the laminating direction.

2. The input device according to claim 1, wherein the first resin flowing direction and the second resin flow direction cross at a right angle.

3. The input device according to claim 1, further comprising a casing joined to the plastic cover.

4. The input device according to claim 2, further comprising a casing joined to the plastic cover.

5. The input device according to claim 3, wherein the casing has a frame shape in a plan view in the laminating direction and is joined to a periphery of the plastic cover.

6. The input device according to claim 4, wherein the casing has a frame shape in a plan view in the laminating direction and is joined to a periphery of the plastic cover.

7. A method for manufacturing an input device including a plastic cover and a film sensor laminated to each other, the method comprising:
providing the plastic cover made of a first resin base material having a first resin flow direction;
providing the film sensor mad of a second resin base material having a second resin flow direction; and
laminating the plastic cover and the film sensor so that the first resin flow direction and the second resin flowing direction are nonparallel to each other.

8. The method according to claim 7,
wherein the first resin flow direction is an extruding direction of the first resin base material in manufacturing the plastic cover.

9. The method according to claim 7,
wherein the second resin flow direction is a roll drawing direction of the second resin base material in manufacturing the film sensor.

10. The method according to claim 8,
wherein the second resin flow direction is a roll drawing direction of the second resin base material in manufacturing the film sensor.

11. The input device according to claim 1, wherein the first resin base material has thermal deformation characteristics to warp in the first resin flow direction such that the plastic cover deforms in the first resin flow direction under heat, while the second resin base material has thermal deformation characteristics to warp in the second resin flow direction such that the film sensor deforms in the second resin flow direction under heat.
